(19) United States
(12) Patent Application Publication
(10) Pub. No.: US 2017/0360158 A1
(43) Pub. Date: Dec. 21, 2017

(54) MULTI-PURPOSE BELT BUCKLE SYSTEM AND METHOD

(71) Applicants: Ross Trottier, Colorado Springs, CO (US); Kellan Smith, Monument, CO (US)

(72) Inventors: Ross Trottier, Colorado Springs, CO (US); Kellan Smith, Monument, CO (US)

(21) Appl. No.: 15/298,211

(22) Filed: Oct. 19, 2016

Related U.S. Application Data
(60) Provisional application No. 62/350,900, filed on Jun. 16, 2016.

(51) Int. Cl. A44B 11/00; B25B 15/00; A45F 5/02; B25H 3/00; B25B 15/02

(52) U.S. Cl. CPC A44B 11/005; B25H 3/006; B25B 15/02; A45F 5/021; B25B 15/005; B25B 15/007; A45F 2005/023

(57) ABSTRACT

A belt buckle adapted for securing a plurality of tools. The multi-purpose belt buckle system includes a first component for screwing a screw and a second component for holding the first component. The first component is T-shaped and includes various types of screwdriver heads. The second component further includes a slot for holding the first component, at least one open wrench and least one means for connecting a strap/lace.

### CROSS-REFERENCE TO RELATED APPLICATION

The present application is related to and claims priority from prior provisional application Ser. No. 62/350,900, filed Jun. 16, 2016, which application is incorporated herein by reference.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of belt buckles and more specifically relates to a multi-purpose belt buckle.

### 2. Description of Related Art

Belts are specifically designed for fastening around the waist of an individual and they usually include some type of belt buckle secured at one end. Many belt buckles are known which may be used as an ornament, and which also may provide additional features or functions. Belts are not typically multi-functional.

Several attempts have been made to solve the above-mentioned problems such as those found in U.S. Pat. Nos. 5,217,150; 5,531,365; and 5,609,280. This art is representative of belt buckles. However, none of the above inventions and patents, taken either singly or in combination, is seen to describe the invention as claimed.

### BRIEF SUMMARY OF THE INVENTION

In view of the foregoing disadvantages inherent in the known belt buckle art, the present invention provides a novel multi-purpose belt buckle. The general purpose of the present invention, which will be described subsequently in greater detail is to provide a providing a belt buckle adapted for securing a plurality of tools. The present invention is superior to other systems in that it effectively secures a screwdriver and at least one wrench.

A multi-purpose belt buckle is disclosed herein, in a preferred embodiment, comprising a multi-purpose belt buckle assembly having a multi-tool, including and defined by a first tool member, a second tool member, a third tool member, a first screwdriver head, a second screwdriver head, and a third screwdriver head; and a buckle body, including and defined by a forward surface, a rearward surface, at least one wrench opening, a multi-tool receiving slot, and a plurality of apertures.

The first tool member, the second tool member, and the third tool member are arranged in a T-shape. Accordingly, the first tool member of the multi-tool is perpendicular to the second tool member of the multi-tool, and the second tool member of the multi-tool is perpendicular to the third tool member of the multi-tool. The first screwdriver head, the second screwdriver head, and the third screwdriver head are each adapted for engaging a screw; the first screwdriver head comprises a star drive bit in a preferred embodiment, while the second screwdriver head comprises a large rectangular drive head in a preferred embodiment, and the third screwdriver head comprises a small rectangular drive head in a preferred embodiment.

The first screwdriver head of the multi-tool, the second screwdriver head of the multi-tool, and the third screwdriver head of the multi-tool may alternatively comprise drive bits selected from a group of flat, star, pointed, polygonal or a combination thereof.

The multi-tool is configured to be manipulated by a user, and to be rotated by hand for the purpose of screwing a screw; the first tool member of the multi-tool, the second tool member of the multi-tool, and the third member of the multi-tool are each adapted to be manipulated as a handle in order to impart torque upon an adjacent tool member. At least one wrench opening of the buckle body is configured to engage a bolt head for rotational manipulation. The buckle body is adapted to be manipulated as a hand tool in order to impart torque upon the wrench opening of the buckle body.

The multi-tool receiving slot of the buckle body is configured to connectably receive the multi-tool, and the plurality of apertures of the buckle body are configured to receive straps or laces for attaching to a waist belt. The apertures of the buckle body comprise a symmetrical array of openings in the buckle body, adjacent to the left and right sides of the buckle body. The buckle body is arranged to be worn by a user as a functional fastening component of a waist belt. The multi-tool is constructed of a high-tensile strength, corrosive resistant metallic alloy.

The buckle body is arranged to include an open end wrench, and the buckle body is structured and arranged to connectably receive the multi-tool. The buckle body is configured to fasten a belt.

The present invention holds significant improvements and serves as a multi-purpose belt buckle. Preferably, a belt buckle should provide storage for accessories for convenient access and, yet would operate reliably and be manufactured at a modest expense. Thus, a need exists for a reliable multi-purpose belt buckle to avoid the above-mentioned problems.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present disclosure, multi-purpose belt buckle, constructed and operative according to the teachings of the present disclosure.

FIG. 1 shows a perspective view illustrating a multi-tool component according to an embodiment of the disclosure.

FIG. 2 is a perspective view illustrating the buckle body component according to an embodiment of the disclosure.

FIG. 3 is a perspective view illustrating the first and second components in a multi-purpose belt buckle assembly according to an embodiment of the present disclosure.

FIG. 4 is a perspective view illustrating a rear view of the multi-purpose belt buckle assembly according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a belt buckle and more particularly to a multi-purpose belt buckle.

Generally speaking, multi-purpose belt buckle comprises a T-shaped first component for screwing a screw, including the first end with a star shaped head, a second end with a rectangular head and a third end with a rectangular head. In general, the present invention provides a belt buckle adapted for securing a plurality of tools, including a first component for screwing a screw and a second component for holding the first component. In various embodiments the present invention provides a T-shaped multi-pointed screwdriver made of high tensile, corrosive resistant metallic alloy, including the first end, the second end and the third end. The heads of the T-shaped multi-pointed screwdriver may be selected from a group of flat, star, pointed, polygonal or a combination thereof.

The device includes a slot for holding the first component, at least one open wrench and least one means for connecting a strap/lace. In various embodiments the present invention provides the buckle frame made of high tensile, corrosive resistant metallic alloy, including the slot for holding the first component, at least one open wrench and least one means for connecting the strap/lace. In a preferred embodiment, the present invention provides the belt buckle adapted for securing a plurality of tools, including the first component for screwing a screw made of stainless steel further including the first end with star shaped head, the second end with rectangular head and the third end rectangular head and the first component is T-Shaped. Further, in this particular embodiment the second component for holding the first component is made of stainless steel, including the T-Shaped slot for holding the multi-pointed screwdriver, three open wrenches and four holes for connection of the laces.

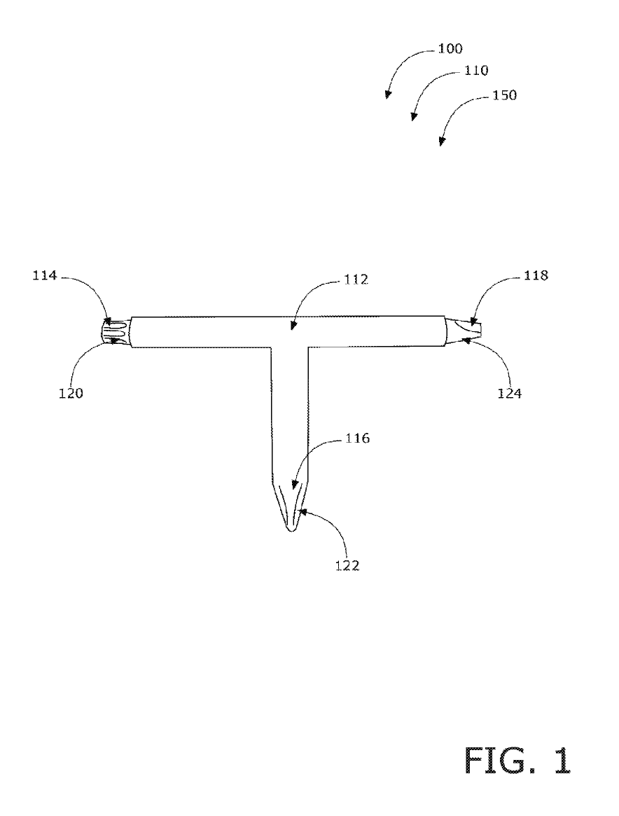

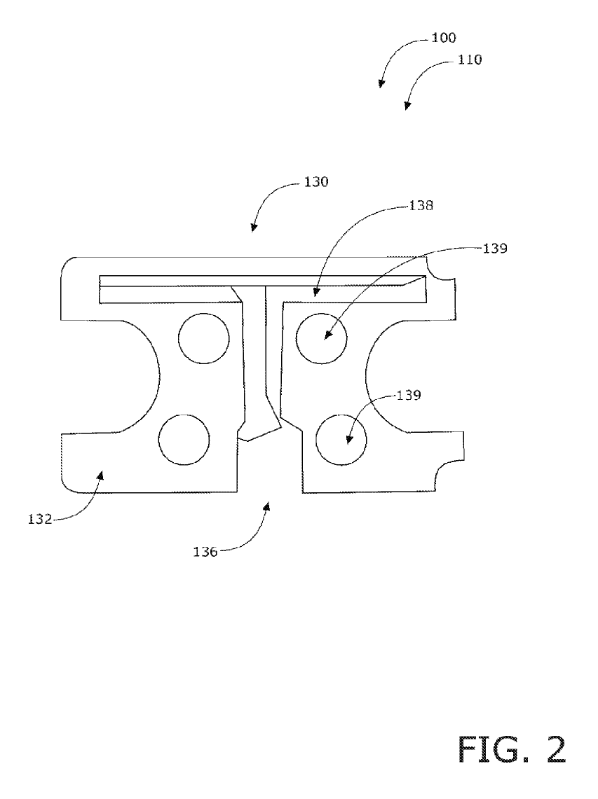

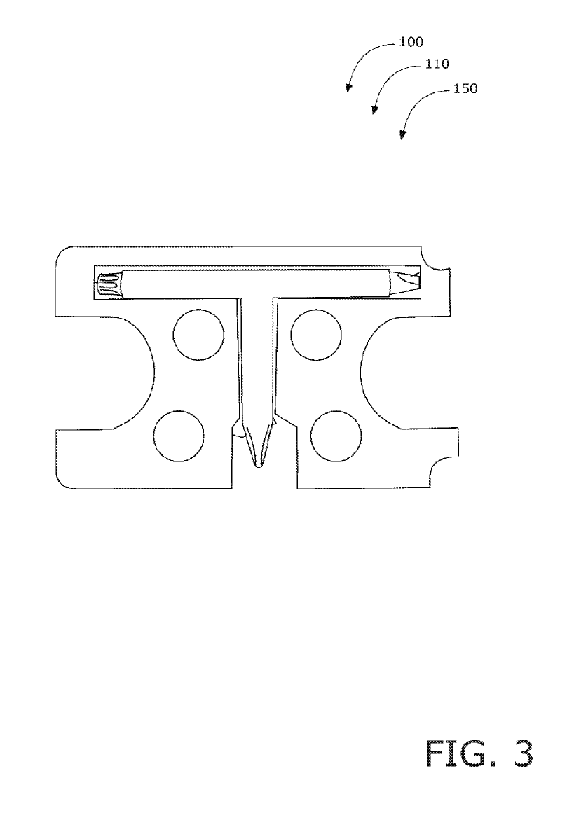

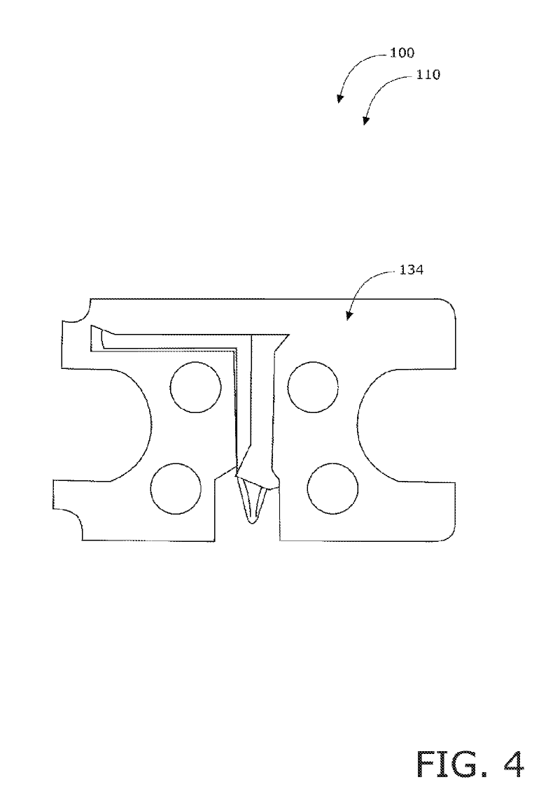

Referring now more specifically to the drawings by numerals of reference there is shown in FIGS. 1-4, various views of the multi-purpose belt buckle system 100 comprising a multi-purpose belt buckle assembly 110 having a multi-tool 112, including and defined by a first tool member 114, a second tool member 116, a third tool member 118, a first screwdriver head 120, a second screwdriver head 122, and a third screwdriver head 124; and a buckle body 130, including and defined by a forward surface 132, a rearward surface 134, at least one wrench opening 136, a multi-tool receiving slot 138, and a plurality of apertures 139. Buckle body 130 is arranged to include an open end wrench. Buckle body 130 is structured and arranged to connectably receive multi-tool 112. Buckle body 130 is configured to fasten a belt.

First tool member 114, second tool member 116, and third tool member 118 are preferably arranged in a T-shape; first tool member 114 of multi-tool 112 is perpendicular to second tool member 116 of multi-tool 112, and second tool member 116 of multi-tool 112 is perpendicular to third tool member 118 of multi-tool 112.

First screwdriver head 120, second screwdriver head 122, and third screwdriver head 124 are each adapted for screwing a screw. First screwdriver head 120 comprises a star drive bit in a preferred embodiment, second screwdriver head 122 comprises a large rectangular drive head in a preferred embodiment, and third screwdriver head 124 comprises a small rectangular drive head in a preferred embodiment. First screwdriver head 120 of multi-tool 112, second screwdriver head 122 of multi-tool 112, and third screwdriver 124 head of multi-tool 112 may comprise drive bits selected from a group of flat, star, pointed, polygonal or a combination thereof.

Multi-tool 112 is configured to be manipulated by a user, and to be rotated by hand for the purpose of screwing a screw. First tool member 114 of multi-tool 112, second tool member 116 of multi-tool 112, and third member 118 of multi-tool 112 are each adapted to be manipulated as a handle in order to impart torque upon an adjacent tool member.

At least one wrench opening 136 of buckle body 130 is configured to engage a bolt head for rotational manipulation, and buckle body 130 is adapted to be manipulated as a hand tool in order to impart torque upon at least one wrench opening 136 of buckle body 130.

Multi-tool receiving slot 138 of buckle body 130 is configured to connectably receive multi-tool 112. Plurality of apertures 139 of buckle body 130 are configured to receive straps or laces for attaching to a waist belt, and comprise a symmetrical array of openings in buckle body 130, adjacent to the left and right sides of buckle body 130. Buckle body 130 is arranged to be worn by a user as a functional fastening component of a waist belt. Multi-tool 112 is preferably constructed of a high-tensile strength, corrosive resistant metallic alloy for durability in use.

Multi-purpose belt buckle system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different tool combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A multi-purpose belt buckle system comprising:
a multi-purpose belt buckle assembly having:
a multi-tool including and defined by:
a first tool member;
a second tool member;
a third tool member;
a first screwdriver head;
a second screwdriver head; and
a third screwdriver head;
a buckle body including and defined by:
a forward surface;
a rearward surface;
at least one wrench opening;
a multi-tool receiving slot; and
a plurality of apertures;
wherein said buckle body is arranged to include an open end wrench;
wherein said buckle body is structured and arranged to connectably receive said multi-tool; and
wherein said buckle body is configured to fasten a belt.

2. The accessory of claim 1, wherein said first tool member, said second tool member, and said third tool member are arranged in a T-shape relative to each other.

3. The accessory of claim 1, wherein said first tool member of said multi-tool is perpendicular to said second tool member of said multi-tool, and said second tool member of said multi-tool is perpendicular to said third tool member of said multi-tool respectively.

4. The accessory of claim 1, wherein said first screwdriver head, said second screwdriver head, and said third screwdriver head are each adapted for screwing a screw.

5. The accessory of claim 1, wherein said first screwdriver head comprises a star drive bit in a preferred embodiment.

6. The accessory of claim 1, wherein said second screwdriver head comprises a large rectangular drive head in a preferred embodiment.

7. The accessory of claim 1, wherein said third screwdriver head comprises a small rectangular drive head in a preferred embodiment.

8. The accessory of claim 1, wherein said first screwdriver head of said multi-tool, said second screwdriver head of said multi-tool, and said third screwdriver head of said multi-tool comprise drive bits selected from a group of flat, star, pointed, and polygonal.

9. The accessory of claim 1, wherein said multi-tool is configured to be manipulated by a user, and to be rotated by hand for the purpose of screwing a screw.

10. The accessory of claim 1, wherein said first tool member of sail multi-tool, said second tool member of said multi-tool, and said third member of said multi-tool are each adapted to be manipulated as a handle in order to impart torque upon an adjacent tool member.

11. The accessory of claim 1, wherein said at least one wrench opening of said buckle body is configured to engage a bolt head for rotational manipulation.

12. The accessory of claim 1, wherein said buckle body is adapted to be manipulated as a hand tool in order to impart torque upon said at least one wrench opening of said buckle body.

13. The accessory of claim 1, wherein said multi-tool receiving slot of said buckle body is configured to connectably receive said multi-tool.

14. The accessory of claim 1, wherein said plurality of apertures of said buckle body are configured to receive straps or laces for attaching to a waist belt.

15. The accessory of claim 1, wherein said plurality of apertures of said buckle body comprise a symmetrical array of openings in said buckle body, adjacent to the left and right sides of said buckle body.

16. The accessory of claim 1, wherein said buckle body is arranged to be worn by a user as a functional fastening component of a waist belt.

17. The accessory of claim 1, wherein said multi-tool is constructed of a high-tensile strength, corrosive resistant metallic alloy.

18. A multi-purpose belt buckle system comprising:
a multi-purpose belt buckle assembly having,
a multi-tool including and defined by,
a first tool member;
a second tool member;
a third tool member;
a first screwdriver head;
a second screwdriver head; and
a third screwdriver head;
a buckle body including and defined by,
a forward surface;
a rearward surface;
at least one wrench opening;
a multi-tool receiving slot; and
a plurality of apertures;
wherein said first tool member, said second tool member, and said third tool member are arranged in a T-shape;
wherein said first tool member of said multi-tool is perpendicular to said second tool member of said multi-tool, and said second tool member of said multi-tool is perpendicular to said third tool member of said multi-tool;
wherein said first screwdriver head, said second screwdriver head, and said third screwdriver head are each adapted for screwing a screw;
wherein said first screwdriver head comprises a star drive bit;
wherein said second screwdriver head comprises a large rectangular drive head;
wherein said third screwdriver head comprises a small rectangular drive head;
wherein said multi-tool is configured to be manipulated by a user, and to be rotated by hand for purposes of engaging a screw;
wherein said first tool member of sail multi-tool, said second tool member of said multi-tool, and said third member of said multi-tool are each adapted to be manipulated as a handle in order to impart torque upon an adjacent tool member;
wherein said buckle body is adapted to be manipulated as a hand tool in order to impart torque upon said at least one wrench opening of said buckle body;
wherein said multi-tool receiving slot of said buckle body is configured to connectably receive said multi-tool;
wherein said buckle body is arranged to be worn by a user as a functional fastening component of a waist belt;
wherein said multi-tool is constructed of a high-tensile strength, corrosive resistant metallic alloy;
wherein said buckle body is structured and arranged to connectably receive said multi-tool; and
wherein said buckle body is configured to fasten a belt.
